(19) United States
(12) Patent Application Publication
(10) Pub. No.: US 2025/0139461 A1
(43) Pub. Date: May 1, 2025

(54) ETHNICITY PREDICTION WITH STRING KERNAL MODEL

(71) Applicant: Ancestry.com DNA, LLC, Lehi, UT (US)

(72) Inventors: Jeffrey Adrion, Salt Lake City, UT (US); Yong Wang, Foster City, CA (US); Yulin Zhang, Berkeley, CA (US)

(21) Appl. No.: 18/927,687

(22) Filed: Oct. 25, 2024

Related U.S. Application Data
(60) Provisional application No. 63/593,865, filed on Oct. 27, 2023.

(51) Int. Cl. G06N 5/01

(52) U.S. Cl. CPC G06N 5/01

(57) ABSTRACT

Disclosed is a method for predicting classification of named entities. The method may include receiving a target inheritance dataset of a target named entity and a plurality of reference inheritance datasets corresponding to a plurality of reference named entities. The method may include generating a feature vector corresponding to the target inheritance dataset by applying a string kernel model to matched data strings between the target inheritance dataset and each of the reference inheritance datasets and generating the feature vector based on results of applying the string kernel model to the matched data strings between the target inheritance dataset and the plurality of reference inheritance datasets. The method may include applying a decision tree model to the feature vector corresponding to the target inheritance dataset and generating an output using the decision tree model. The output may provide information associated with a data classification of the target named entity.

### CROSS-REFERENCE TO RELATED APPLICATIONS

This application claims the benefit of U.S. Provisional Application No. 63/593,865, filed Oct. 27, 2023, which is incorporated by reference herein in its entirety.

### FIELD

The disclosed embodiments relate to assigning labelling to data instances, particularly, to determining data inheritances using a string kernel model.

### BACKGROUND

A large-scale database can include billions of data records. This type of database may allow users to build connections, research history, and make meaningful discoveries about past events. Users may try to identify related records within the database. However, identifying connections in the sheer amount of data is not a trivial task. Datasets associated with different users may not be connected without a proper determination of how the datasets are related. Comparing a large number of datasets without a concrete strategy may also be computationally infeasible because each dataset may also include a large number of data bits. Given a user dataset and a database with datasets that are potentially related to the user dataset, it is often challenging to identify a dataset in the database that is associated with the user dataset.

In an inheritance dataset, a recombination point, also known as a recombination breakpoint, refers to a specific location or position along a data string where a recombination event has occurred. Recombination is the process by which segments of an inheritance dataset from two parent inheritance datasets are shuffled or exchanged, resulting in a new combination of inheritance material in their offspring. Recombination points mark the boundaries where this exchange of inheritance material has taken place. Current data classification methods often identify matched data strings of inheritance datasets based on the patterns of matched single data points in an inheritance sequence without considering the recombination points or the continuity of the matched data strings.

### SUMMARY

Disclosed herein relates to a method for predicting classification of named entities. The method may include receiving a target inheritance dataset of a target named entity and a plurality of reference inheritance datasets corresponding to a plurality of reference named entities. The method may include generating a feature vector corresponding to the target inheritance dataset by applying a string kernel model to matched data strings between the target inheritance dataset and each of the reference inheritance datasets and generating the feature vector based on results of applying the string kernel model to the matched data strings between the target inheritance dataset and the plurality of reference inheritance datasets. The method may include applying a decision tree model to the feature vector corresponding to the target inheritance dataset and generating an output using the decision tree model. The output may provide information associated with a data classification of the target named entities.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 illustrates a diagram of a system environment of an example computing system, in accordance with some embodiments.

FIG. 2 is a block diagram of an architecture of an example computing system, in accordance with some embodiments.

FIG. 3 is a flowchart depicting an example process for predicting ethnicity using a string kernel model, in accordance with some embodiments.

FIG. 4A is a conceptual diagram illustrating exemplary comparisons of two target haplotype datasets with a reference haplotype dataset, in accordance with some embodiments.

FIG. 4B illustrates a string kernel computation with triangular numbers visualized for a target haplotype dataset and one reference haplotype dataset, in accordance with some embodiments.

FIG. 4C is a conceptual diagram illustrating a process of generating a feature vector for the target haplotype dataset, in accordance with some embodiments.

FIG. 4D is a block diagram illustrating a process for determining ethnicity estimation of a target individual based on the genetic dataset of the target individual, in accordance with some embodiments.

FIG. 4E is a flowchart depicting another example process for predicting ethnicity using a string kernel model, in accordance with some embodiments.

FIG. 5 illustrates a structure of an example neural network, in accordance with some embodiments.

FIG. 6 is a block diagram of an example computing device, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed are techniques for predicting assignments of individuals to communities or ethnicities based on haploid data. The disclosed method takes account of the recombination points and the continuity of the matched segments in the haploid data. In some embodiments, the mismatches/variances between haplotype datasets may be associated with genotypic recombination, mutations, genotyping errors, etc. In particular, recombination points in the haplotype data mark the boundaries where the mixing and matching of genetic material has taken place. Fewer mismatched sites and longer contiguous matched segments may indicate less genotypic recombination has taken place; alternatively, more mismatched sites and shorter matched segments may indicate more genotypic recombination has taken place. The disclosed method may apply a string kernel model to matched segments between a target haplotype dataset and the reference haplotype datasets and generate a feature vector based on results of applying the string kernel model. In some embodiments, the string kernel model determines a similarity metric based on a polynomial value for contiguous matched sites of the matched segments between the target haplotype dataset and each of the reference haplotype datasets. The method applies a decision tree model to the feature vector and generates an output that provides information associated with a community prediction for the target haplotype dataset.

The method disclosed herein considers the mismatched sites introduced by the genotypic recombination and assigns more weight to longer, contiguous matched sites. This weighting method enhances the accuracy of the similarity measurement by emphasizing the importance of substantial and uninterrupted matches in determining how similar the two haploid datasets are to each other. In this way, the disclosed method provides a more accurate reflection of similarity between the target and reference haplotype datasets, yields higher local accuracy, and improves fine-scale discrimination between genomic variations.

### Example System Environment

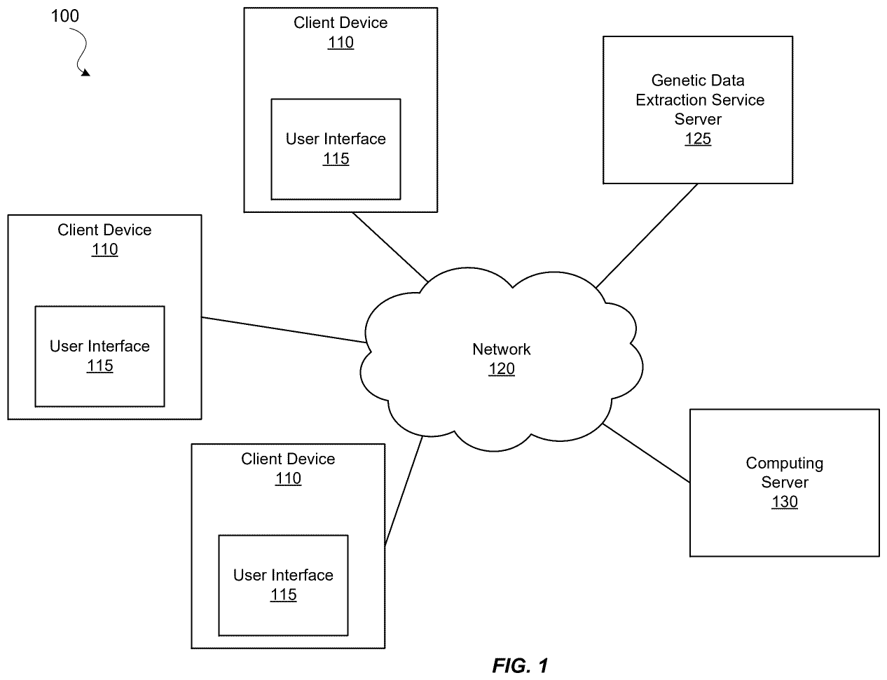

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet-switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as microarray, amplification and/or sequencing. Microarray may include immobilizing probe DNA sequences, onto a solid surface such as a glass slide. Target DNA samples, labeled with fluorescent tags, are then applied to the microarray surface. Through complementary base pairing, the labeled DNA binds to its corresponding probe on the microarray. By detecting the fluorescence emitted by the labeled DNA, genetic data may be extracted. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 extracts genetic data from the samples and the data may take the form of a set of SNPs. The genetic data extraction service server 125 generates the genetic data of the individuals based on sequencing or microarray results. The genetic data may include data generated from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from DNA identification results, for example by identifying genotype values of single nucleotide polymorphisms (SNPs) present within the DNA. The results in this example may include a sequence of genotypes corresponding to various SNP sites. A SNP site may also be referred to as a SNP loci. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at target SNP sites. Since a typical human genome may differ from a reference human genome at only several million SNP sites (as opposed to billions of base pairs in the whole genome), the genetic data extraction service server 125 may extract only the genotypes at a set of target SNP sites and transmit the extracted data to the computing server 130 as the inheritance dataset of an individual. SNPs, base pair sequences, genotypes, haplotypes, RNA sequences, protein sequences, and phenotypes are examples of biomarkers. In some embodiments, each SNP site may have two readings that are heterozygous.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed on the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to the user's privacy setting and authorization, the computing server 130 may allow information generated from the user's inheritance dataset to be linked to the user profile and to one or more of the family trees. The users may also authorize the computing server 130 to analyze their inheritance dataset and allow their profiles to be discovered by other users.

### Example Computing Server Architecture

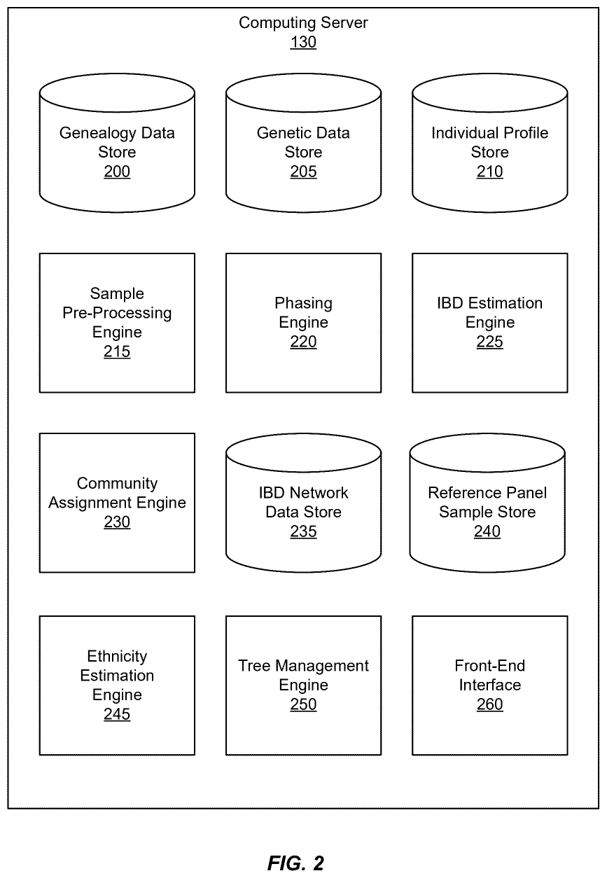

FIG. 2 is a block diagram of the architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a front-end interface 260, and a tree management engine 250. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections between a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains inheritance datasets of individuals in the genetic data store 205. An inheritance dataset of an individual may be a digital dataset of nucleotide data (e.g., SNP data) and corresponding metadata. For example, an inheritance dataset may be genetic data extracted by the genetic data extraction service server 125. An inheritance dataset may contain data on the whole or portions of an individual's genome. The genetic data store 205 may store a pointer to a location associated with the genealogy data store 200 associated with the individual. An inheritance dataset may take different forms. In some embodiments, an inheritance dataset may take the form of a base pair sequence of the sequencing result of an individual. A base pair sequence dataset may include the whole genome of the individual (e.g., obtained from a whole-genome sequencing) or some parts of the genome (e.g., genetic loci of interest). A microarray data may take the form of SNP data at target positions in the genome.

In another embodiment, an inheritance dataset may take the form of sequences of genetic markers. Examples of genetic markers may include target SNP sites (e.g., allele sites) filtered from the DNA identification results. A SNP site that is a single base pair long may also be referred to as a SNP locus. A SNP site may be associated with a unique identifier. The inheritance dataset may be in the form of diploid data that includes a sequence of genotypes, such as genotypes at the target SNP site, or the whole base pair sequence that includes genotypes at known SNP sites and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating inheritance datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to the environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users' preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and research conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide heightened privacy as a default setting for certain types of data, such as genetic data or any data that the user marks as sensitive. The user may opt in to sharing those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

In some embodiments, the individual profile store 210 may be a large-scale data store. In some embodiments, the individual profile store 210 may include at least 10,000 data records in the form of user profiles and one or more user profiles may be associated with one or more inheritance datasets and one or more genealogical data entries. In some embodiments, the individual profile store 210 may include at least 50,000 data records in the form of user profiles and one or more user profiles may be associated with one or more inheritance datasets and one or more genealogical data entries. In some embodiments, the individual profile store 210 may include at least 100,000 data records in the form of user profiles and one or more user profiles may be associated with one or more inheritance datasets and one or more genealogical data entries. In some embodiments, the individual profile store 210 may include at least 500,000 data records in the form of user profiles and one or more user profiles may be associated with one or more inheritance datasets and one or more genealogical data entries. In some embodiments, the individual profile store 210 may include at least 1,000,000 data records in the form of user profiles and one or more user profiles may be associated with one or more inheritance datasets and one or more genealogical data entries. In some embodiments, the individual profile store 210 may include at least 2,000,000 data records in the form of user profiles and one or more user profiles may be associated with one or more inheritance datasets and one or more genealogical data entries. In some embodiments, the individual profile store 210 may include at least 5,000,000 data records in the form of user profiles and one or more user profiles may be associated with one or more inheritance datasets and one or more genealogical data entries. In some embodiments, the individual profile store 210 may include at least 10,000,000 data records in the form of user profiles and one or more user profiles may be associated with one or more inheritance datasets and one or more genealogical data entries.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from the genetic data extraction service server 125. The genetic data extraction service server 125 may perform laboratory analysis of biological samples of users and generate sequencing results in the form of digital data. The sample pre-processing engine 215 may receive the raw inheritance datasets from the genetic data extraction service server 125. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's inheritance dataset. In some embodiments, the SNPs may be autosomal SNPs. In some embodiments, 700,000 SNPs may be identified in an individual's data and may be stored in genetic data store 205. Alternatively, in some embodiments, an inheritance dataset may include at least 10,000 SNP sites. In another embodiment, an inheritance dataset may include at least 100,000 SNP sites. In yet another embodiment, an inheritance dataset may include at least 300,000 SNP sites. In yet another embodiment, an inheritance dataset may include at least 1,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases a diploid inheritance dataset into a pair of haploid inheritance datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to conditions and other constraints in sequencing or microarray, a DNA identification result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's inheritance datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

A phasing algorithm may also generate phasing result that has a long genomic distance accuracy and cross-chromosome accuracy in terms of haplotype separation. For example, in some embodiments, an IBD-phasing algorithm may be used, which is described in further detail in U.S. Patent Application Publication No. US 2021/0034647, entitled “Clustering of Matched Segments to Determine Linkage of Dataset in a Database,” published on Feb. 4, 2021. For example, the computing server 130 may receive a target individual genotype dataset and a plurality of additional individual genotype datasets that include haplotypes of additional individuals. For example, the additional individuals may be reference panels or individuals who are linked (e.g., in a family tree) to the target individual. The computing server 130 may generate a plurality of sub-cluster pairs of first parental groups and second parental groups. Each sub-cluster pair may be in a window. The window may correspond to a genomic segment and has a similar concept of window used in the ethnicity estimation engine 245 and the rest of the disclosure related to HMMs, but how windows are precisely divided and defined may be the same or different in the phasing engine 220 and in an HMM. Each sub-cluster pair may correspond to a genetic locus. In some embodiments, each sub-cluster pair may have a first parental group that includes a first set of matched haplotype segments selected from the plurality of additional individual datasets and a second parental group that includes a second set of matched haplotype segments selected from the plurality of additional individual datasets. The computing server 130 may generate a super-cluster of a parental side by linking the first parental groups and the second parental groups across a plurality of genetic loci (across a plurality of sub-cluster pairs). Generating the super-cluster of the parental side may include generating a candidate parental side assignment of parental groups across a set of sub-cluster pairs that represent a set of genetic loci in the plurality of genetic loci. The computing server 130 may determine the number of common additional individual genotype datasets that are classified in the candidate parental side assignment. The computing server 130 may determine the candidate parental side assignment to be part of the super-cluster based on the number of common additional individual genotype datasets. Any suitable algorithms may be used to generate the super-cluster, such as a heuristic scoring approach, a bipartite graph approach, or another suitable approach. The computing server 130 may generate a haplotype phasing of the target individual from the super-cluster of the parental side.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish who immigrated to America in 1800, Irish who immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their inheritance datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, inheritance datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's inheritance dataset belongs or does not belong to the community of interest. A multi-class classifier such as a neural network may also be trained to determine whether the target individual's inheritance dataset most likely belongs to one of several possible genetic communities.

Reference panel sample store 240 stores reference panel samples for different genetic communities. A reference panel sample is the genetic data of an individual whose genetic data is the most representative of a genetic community. The genetic data of individuals with typical alleles of a genetic community may serve as reference panel samples. For example, some alleles of genes may be over-represented (e.g., being highly common) in a genetic community. Some inheritance datasets include alleles that are commonly present among members of the community. Reference panel samples may be used to train various machine learning models in classifying whether a target inheritance dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., containing fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times the node is sampled, the inheritance dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors were born at a certain birthplace. The computing server 130 may also draw sequence data from the Human Genome Diversity Project (HGDP). Various candidates may be manually screened based on their family trees, relatives' birth location, and other quality controls. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of an inheritance dataset of a target individual. The inheritance datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target inheritance dataset into a plurality of windows (e.g., about 1000 windows). Each window includes a small number of SNPs (e.g., 300 SNPs). The ethnicity estimation engine 245 may use a directed acyclic graph model to determine the ethnic composition of the target inheritance dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target inheritance dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target inheritance dataset by determining the label compositions of the nodes that are included in the determined path. U.S. Pat. No. 10,558,930, entitled “Local Genetic Ethnicity Determination System,” granted on Feb. 11, 2020, and U.S. Pat. No. 10,692,587, granted on Jun. 23, 2020, entitled “Global Ancestry Determination System” describe different example embodiments of ethnicity estimation.

The tree management engine 250 performs computations and other processes related to users' management of their data trees such as family trees. The tree management engine 250 may allow a user to build a data tree from scratch or to link the user to existing data trees. In some embodiments, the tree management engine 250 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 250 may receive an inheritance dataset from the target individual as input and search related individuals that are IBD-related to the target individual. The tree management engine 250 may identify common ancestors. Each common ancestor may be common to the target individual and one of the related individuals. The tree management engine 250 may in turn output potential family trees to which the target individual may belong by retrieving family trees that include a common ancestor and an individual who is IBD-related to the target individual. The tree management engine 250 may further identify one or more probable positions in one of the potential family trees based on information associated with matched genetic data between the target individual and those in the potential family trees through one or more machine learning models or other heuristic algorithms. For example, the tree management engine 250 may try putting the target individual in various possible locations in the family tree and determine the highest probability position(s) based on the inheritance dataset of the target individual and inheritance datasets available for others in the family tree and based on genealogy data available to the tree management engine 250. The tree management engine 250 may provide one or more family trees from which the target individual may select. For a suggested family tree, the tree management engine 250 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 250 may automatically search, rank, and suggest individuals for the user conduct manual reviews as the user makes progress in the front-end interface 260 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

The front-end interface 260 may render a front-end platform that displays various results determined by the computing server 130. The platform may take the form of a genealogy research and family tree building platform and/or a personal DNA data analysis platform. The platform may also serve as a social networking system that allows users and connect and build family trees and research family relations together. The results and data may include the IBD affinity between a user and another individual, the community assignment of the user, the ethnicity estimation of the user, phenotype prediction and evaluation, genealogy data search, family tree and pedigree, relative profile and other information. The front-end interface 260 may allow users to manage their profile and data trees (e.g., family trees). The users may view various public family trees stored in the computing server 130 and search for individuals and their genealogy data via the front-end interface 260. The computing server 130 may suggest or allow the user to manually review and select potentially related individuals (e.g., relatives, ancestors, close family members) to add to the user's data tree. The front-end interface 260 may be a graphical user interface (GUI) that displays various information and graphical elements.

The front-end interface 260 may take different forms. In one case, the front-end interface 260 may be a software application that can be displayed on an electronic device such as a computer or a smartphone. The software application may be developed by the entity controlling the computing server 130 and be downloaded and installed on the client device 110. In another case, the front-end interface 260 may take the form of a webpage interface of the computing server 130 that allows users to access their family tree and genetic analysis results through web browsers. In yet another case, the front-end interface 260 may provide an application program interface (API). In some embodiments, the front-end interface 260 may be rendered as part of the content in an extended reality device, such as a head-mounted display or a phone camera that is integrated with augmented reality features.

The front-end interface 260 may provide various front-end visualization features. In some embodiments, a family tree viewer may render family tree built by users and/or managed by the tree management engine 250. The family tree may be displayed in a nested nodes and edges connected based on family relationships or genetic matches determined by various genetic data analysis engines discussed in FIG. 2. The family trees may include attached records that are part of records in the genealogy data store 200, including records that are uploaded by users and gallery images. The user may assign a focal person to a family tree and the family tree is displayed with the focus (such as positioning the focal person at the center or relative prominent position of the tree) around the focal person. A user may change the focal person and the family tree may shift accordingly based on the relationships and relative positions of members in the family tree. Each person in the family tree may be associated with historical photos from gallery images, historical genealogy records such as life event records, one or more stories and live events associated with the person, and metadata such as family relationships and other family trees associated with the person.

In some embodiments, visualization features provided by the front-end interface 260 may include a map feature. A map may be a geographical map that may take the form of a digital map, a historical physical map, and/or a historical map overlaid on a digital map. A user may select a geographical location and the front-end interface 260 displays relevant genealogical or genetic records associated with the location, such as an ancestor's lifetime events, birth locations of DNA matches, mitigation patterns of ancestors across different locations over time and associated genealogical records, residence maps that provide specific locations of historical persons' events, and historical maps overlaying on a digital map to contextualize ancestors' records and events. The map feature may also provide interactive features to allow users to view historical documents, photographs, and stores associated with the geographical locations. The map feature may also allow users to adjust timeframes, displaying changes in locations and migrations over different periods.

In some embodiments, visualization features provided by the front-end interface 260 may include a story feature that provides multimedia narratives about a person, such as the person's live events and family history. The story feature allows a user to compile various graphical and genealogical elements such as photos, documents, historical records, and personal anecdotes into a timeline to summarize a narrative. The story may be arranged in an appropriate spatial manner such as a linear arrangement that arranges various graphical elements based on the creator's selection.

In this disclosure, genetic data may be an example of inheritance data. An individual is an example of a named entity. A genetic sequence is an example of data string or bit string. A genetic segment is an example of data string segment. A matched genetic segment is an example of matched data string. For example, an IBD segment is an example of a matched data string segment. An ethnicity is an example or a data origin or a data classification. A phenotype is an example of a data manifestation. A reproductive event is an example of a data inheritance event.

### Ethnicity Prediction Using String Kernel Model

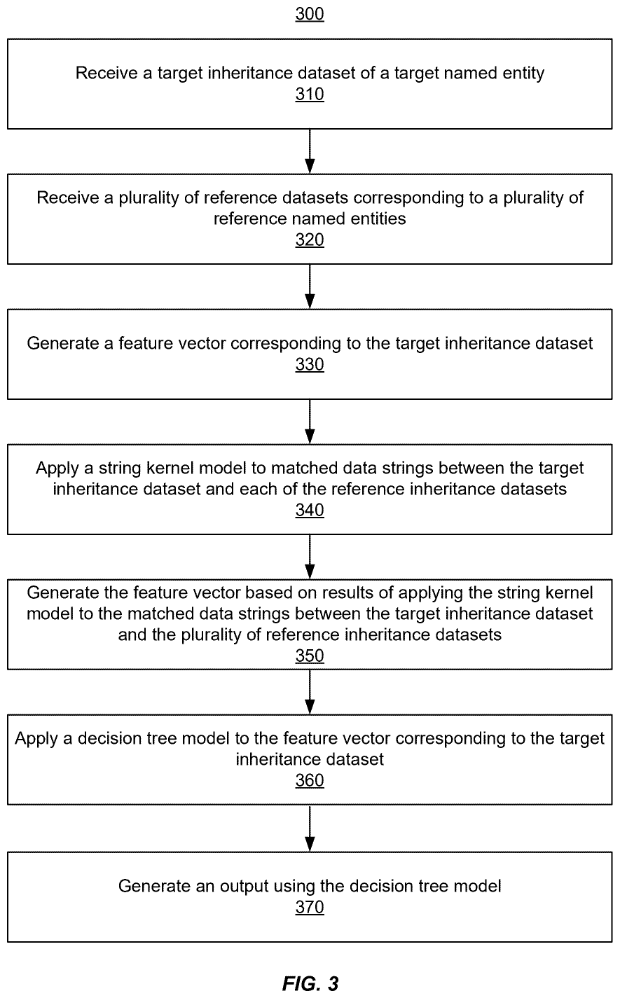

FIG. 3 is a flowchart depicting an example process 300 for predicting a data classification using a string kernel model, in accordance with some embodiments. While in the discussion below the haplotype dataset is used as the main example of the inheritance data, various embodiments may also apply to other suitable inheritance data. The process may be performed by one or more engines of the computing server 130 illustrated in FIG. 2, such as ethnicity estimation engine 245. The process 300 may be embodied as a software algorithm that may be stored as computer instructions that are executable by one or more processors. The instructions, when executed by the processors, cause the processors to perform various steps in the process 300. In various embodiments, the process may include additional, fewer, or different steps. While various steps in process 300 may be discussed with the use of computing server 130, each step may be performed by a different computing device.

In some embodiments, process 300 can include receiving 310 a target inheritance dataset of a target named entity. A target individual may be an example of a target named entity. A haplotype may be an example of an inheritance dataset and may also be referred to as a phased inheritance dataset. As used herein, “haplotype,” “haplotype dataset,” and “haploid data” may be used interchangeably. The target haplotype dataset may be a haplotype dataset phased from the genotype of the target individual and can be used to extract features for ethnicity prediction. In some embodiments, the computing server 130 may select one or more sub-segments of the target haplotype dataset as an input for ethnicity prediction. In some embodiments, the target haplotype dataset or its sub-segments are not directly inputted into an ethnicity prediction/community classifier model. Instead, the target haplotype dataset is compared to reference individuals in the community and the comparison results may serve as the features.

Continuing with reference to FIG. 3, in some embodiments, process 300 can include receiving 320 a plurality of reference inheritance datasets corresponding to a plurality of reference named entities. A target individual may be an example of a target named entity. A haplotype may be an example of an inheritance dataset and may also be referred to as a phased inheritance dataset. Each reference haplotype dataset belongs to a reference individual. An individual having the selected haplotype dataset that is representative of a community may be determined as a reference individual who belongs to the community. In some embodiments, each community may include a set of reference individuals. To determine if a target individual is a member of additional communities, the computing server 130 may access a different plurality of reference haplotype datasets associated with a different plurality of reference individuals. For example, there are reference haplotype datasets to determine if an individual belongs to an Irish community, a Jewish community, or a Finnish community. As used herein, “community” may refer broadly to any suitable classification of datasets and/or individuals, and may refer to ethnicities, such as those representing genetic patterns over hundreds or thousands of years, genetic communities, such as those representing genetic patterns over decades or hundreds of years, or other classifications as suitable.

Continuing with reference to FIG. 3, in some embodiments, process 300 can include generating 330 a feature vector corresponding to the target inheritance dataset. A haplotype may be an example of an inheritance dataset and may also be referred to as a phased inheritance dataset. In some embodiments, the computing server 130 may compare the target haplotype dataset to the reference haplotype datasets of the reference individuals and use the comparison results to generate the feature vectors for the target haplotype dataset. In some implementations, the computing server 130 may divide the target haplotype dataset and each of the reference haplotype datasets into a plurality of reference regions of sequential SNPs and compare the target haplotype dataset with each of the reference haplotype datasets in each reference region. For example, using a standard bitwise XOR operator on the haplotype bits, the computing server 130 may determine the number of the haplotype's matched segments, e.g., IBD matches, and obtain a distribution of the comparison results. The matched segments may be defined based on the range of cM shared between the individual's haplotype and the IBD match. In some embodiments, the matched segments may be described using contiguous matched SNPs, their respective map lengths (CM), and/or the number of matched SNPs, etc.

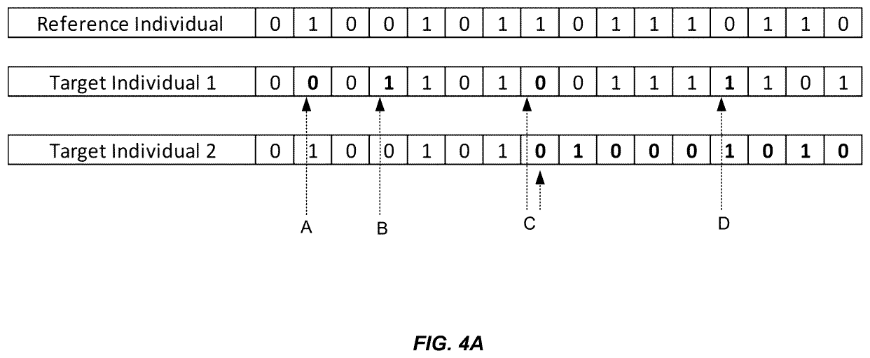

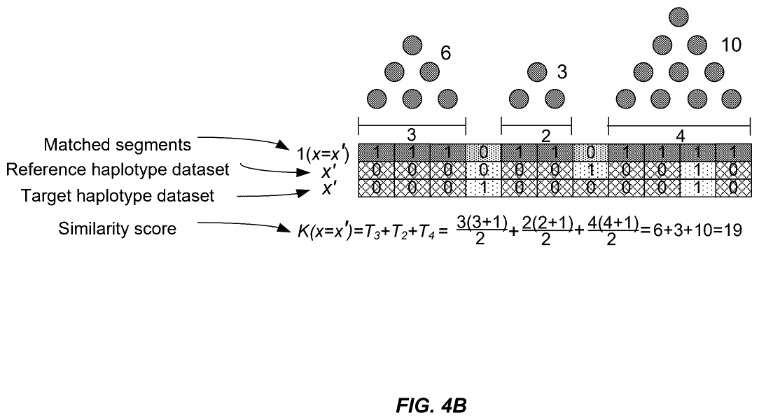

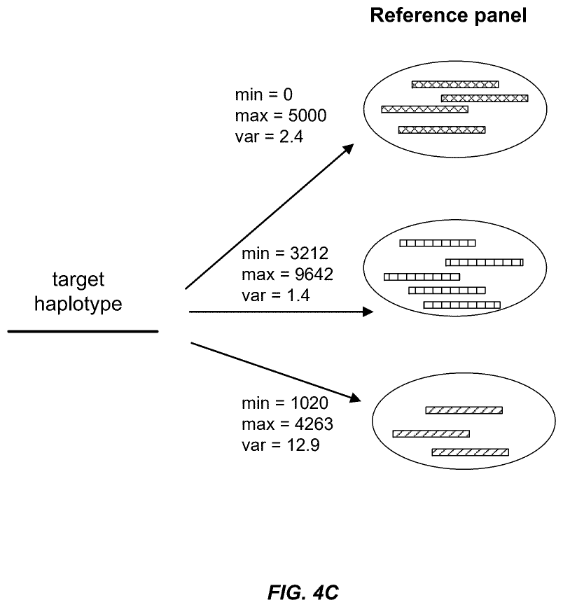

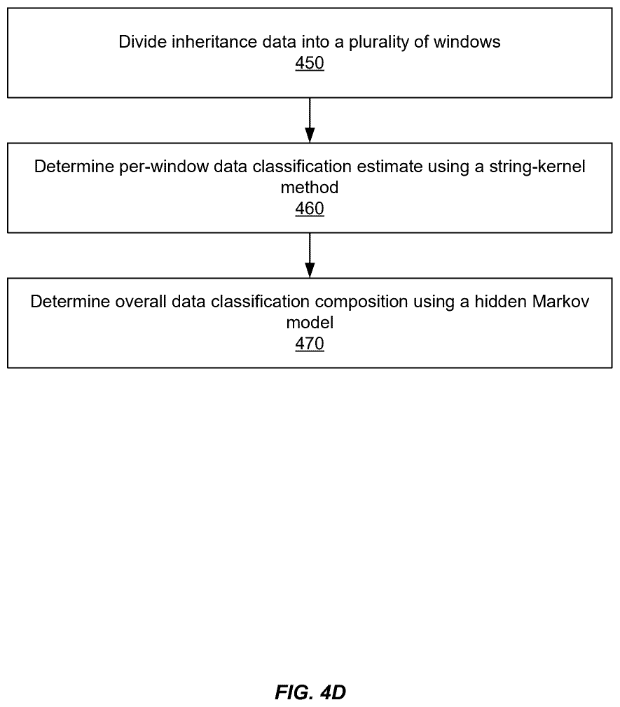

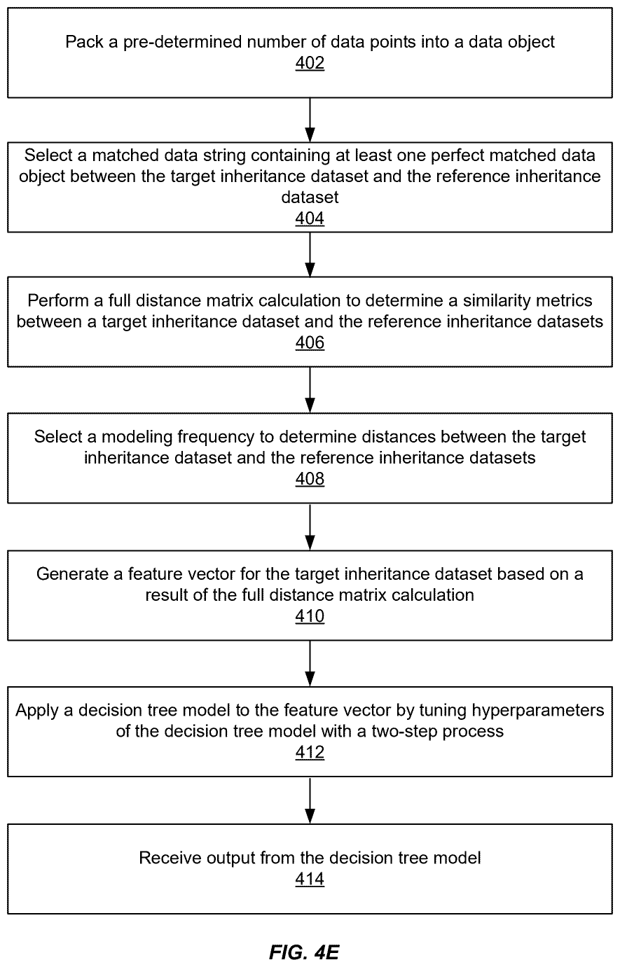

FIG. 4A is a conceptual diagram illustrating exemplary comparisons of two target haplotype datasets with a reference haplotype dataset, in accordance with some embodiments. The target haplotype datasets belong to the two target individuals, i.e., the target individual 1 and the target individual 2, respectively; and the reference haplotype dataset belongs to the reference individual. As shown in FIG. 4A, each of the haplotype datasets is represented as a sequence of alleles, with each allele site having a value of “0” or “1.” To identify the matched segments between the target haplotype datasets and the reference haplotype dataset, the computing server 130 may compare the value of each allele site, i.e., “0” or “1.” Between two haplotype datasets, a same value at the same allele site indicates a match and different values at the same allele site indicate a mismatch. For example, in FIG. 4A, the target haplotype dataset 1 of the target individual 1 has mismatches at sites A, B, C, and D with respect to the reference haplotype dataset; and the target haplotype dataset 2 of the target individual 2 has mismatches starting from site D with respect to the reference haplotype dataset. Based on the identified mismatch sites, the computing server 130 may identify the matched segments between the target haplotype dataset and the reference haplotype dataset. In this example, the target haplotype dataset 1 may have several shorter contiguous matched segments, such as, the SNPs between site B and site C, the SNPs between site C and site D, etc. The target haplotype dataset 2 may have one longer contiguous matched segment, e.g., the SNPs before site C.

In some embodiments, the mismatches/variances in a haplotype dataset may be associated with genotypic recombination, i.e., creating new haplotypes by mixing and matching alleles from the parental chromosomes. The mismatched sites shown in FIG. 4A (e.g., sites A, B, C, and D) may be referred to as recombination points, e.g., locations or sites along a chromosome where a genetic recombination event has occurred. In some embodiments, recombination points mark the boundaries where the mixing and matching of genetic material has taken place. Fewer mismatched sites and longer contiguous matched segments may indicate less genotypic recombination has taken place; alternatively, more mismatched sites and shorter matched segments may indicate more genotypic recombination has taken place. Therefore, in FIG. 4A, although the target haplotype dataset 1 has only 4 mismatched sites whereas the target haplotype dataset 2 has 9 mismatched sites, because the target haplotype dataset 2 has a longer contiguous matched segment, i.e., the SNPs before site C, it is more likely that the target haplotype dataset 2 has less genotypic recombination, and thus is more likely to be more closely related to the reference haplotype than the target haplotype dataset 1.

In order to count for the contiguous matched segments, the computing server 130 may apply 340 a string kernel model to the matched data strings to determine a similarity metric between a target inheritance dataset and the reference inheritance dataset. A segment of a haplotype may be an example of a data string and may also referred to as a segment of phased inheritance dataset. A haplotype may be an example of an inheritance dataset and may also be referred to as a phased inheritance dataset. FIG. 4B illustrates a string kernel computation with triangular numbers visualized for a target haplotype dataset (x) and one reference haplotype dataset (x′), in accordance with some embodiments. The computing server 130 may apply a string kernel model to matched segments between the target haplotype dataset and each of the reference haplotype datasets, e.g. each of the reference haplotype datasets corresponding to a particular community, such as for the purpose of determining whether to assign the target haplotype dataset to the particular community. The string kernel model determines a similarity metric based on a polynomial value for contiguous matched sites of the matched segments between the target haplotype dataset and each of the reference haplotype datasets.

As shown in FIG. 4B, the computing server 130 may compare the sequences of the target haplotype dataset (x) and one reference haplotype dataset (x′), identify and label the matched sites with value “1,” identify and label the mismatched sites with value “0.” Instead of counting the total number of individual matched sites, the computing server 130 may apply a string kernel model to the matched segments, which may give weights to contiguous matched segments. In some embodiments, different weights may be assigned to the contiguous matched segments. For example, a matched segment with 50 contiguous matched SNPs weighs more than a matched segment with five continuous matched SNPs.

In some embodiments, the string kernel model (K) may include a sum of a polynomial value for contiguous matched SNPs.

$${K}_{1} ( x , {x}^{′} ) = {\sum }_{k = 1}^{λ} {\sum }_{n = 1}^{μ} ( \frac{1}{2} {k}^{M} + \frac{1}{2} k ) , \qquad ( 1 )$$

Here, λ is the number of unique sites for a particular reference region/window in a reference panel. A reference region of unique λ-mers (e.g., 500-mers) indicates a reference window of λ number of unique sites (e.g., 500 unique sites). k refers to the length of a sub-string, which indicates a number of contiguous matched sites in a matched segment, e.g., 3-mers, 4-mers, 20-mers, etc. k may range from 0 to λ. M is associated with the weight assigned to the contiguous matched segment. A larger M indicates a higher weight. The computing server 130 applies the string kernel model to the matched segments between a target haplotype dataset and a reference haplotype dataset to calculate a similarity score, which serves as a measure for the genetic relatedness between the target haplotype dataset and the reference haplotype dataset.

In one example, as shown in FIG. 4B, the computing server 130 identifies a first matched segment with 3 contiguous matched SNPs (i.e., a 3-mer), a second matched segment with 2 contiguous matched SNPs (i.e., a 2-mer), and a third matched segment with 4 contiguous matched SNPs (i.e., a 4-mer). The computing server 130 applies the string kernel model to the identified 3 matched segments and calculates a similarity score (e.g., as shown, 19 as the result of applying the described modality to the three segments between the target haplotype datasets and the reference haplotype dataset) for the haplotype dataset (x) and the one reference haplotype dataset (x′). The similarity score may indicate a level of similarity between the target haplotype dataset and the reference haplotype dataset.

In some embodiments, the string kernel model may include a sum of a product of polynomial values for contiguous matched SNPs and their respective map lengths (cM). In some embodiments, the string kernel model may include a sum of polynomial values of the product between contiguous matched SNPs and their respective map lengths (cM). In some embodiments, the string kernel model may include a sum of the polynomial value of transformed map length (cM) for contiguous matched runs. In some implementations, a single mismatch site may be ignored and treated as a match such that a longer contiguous matched segment is not broken due to this mismatch site. In some implementations, the computing server 130 may apply the string kernel model to longer contiguous matched segments and ignore shorter contiguous matched segments. For example, the computing server 130 may not apply the string kernel model to matched segments with k<20 for calculating the similarity score of a target haplotype dataset and the reference haplotype dataset.

FIG. 4C is a conceptual diagram illustrating a process of generating a feature vector for the target haplotype dataset using the results of the applying the string kernel model, in accordance with some embodiments. For each reference region, the computing server 130 may apply the string kernel model to matched segments between the target haplotype dataset and each of the reference haplotype datasets. The computing server 130 may obtain a distribution of similarity scores between the target haplotype dataset and the plurality of the reference haplotype datasets. Based on the distribution, the computing server 130 may select features of the target haplotype dataset for ethnicity prediction. For example, the computing server 130 may obtain characteristics parameters of the similarity score distribution, e.g., minimum similarity score, maximum similarity score, mean similarity score, median similarity score, variance of the distribution, standard deviation, etc.

The computing server 130 may apply the string kernel model and generate the corresponding features for each reference region (or community). For example, the computing server 130 may select one or more similarity score distribution characteristics, e.g., 3 features (max, min, variance), as the features for each reference region. Assuming the total number of reference regions is n, the computing server 130 may select the same features for each reference region, thus, generating a 3n feature vector for the target haplotype. In this way, the computing server 130 generates 350 the feature vector based on results of applying the string kernel model to the matched data strings between the target haplotype dataset and the plurality of reference haplotype datasets.

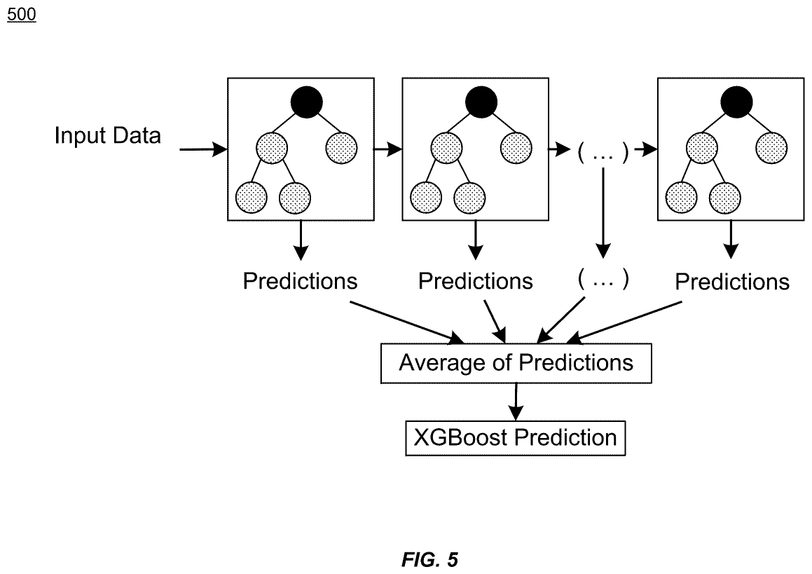

Continuing with reference to FIG. 3, in some embodiments, process 300 can include applying 360 a decision tree model to the feature vector corresponding to the target inheritance dataset. A haplotype may be an example of an inheritance dataset and may also be referred to as a phased inheritance dataset. In some embodiments, the decision tree model is a machine learning model. In some embodiments, the decision tree model is a model of computation in which an algorithm is considered to be basically a decision tree, i.e., a sequence of queries or tests that are done adaptively, so the outcome of previous tests can influence the tests performed next. In some embodiments, the computing server 130 may apply one or more of the decision tree models, including but not limited to, Classification and Regression Trees (CART) model, Random Forest model, Gradient Boosting Trees model (e.g., XGBoost, LightGBM, CatBoost, etc.), Regression Trees model, etc. The computing server 130 may use the results from applying the string kernel model to generate feature vectors for training the decision tree model. For example, in an XGBoost model, the computing server 130 may use the feature vectors to iterate over the weaker learners and add new trees to the model. In some implementations, a single decision tree model is trained across all genomic windows; alternatively, a decision tree model is trained for each window separately. Further detail on the machine learned decision tree model is described in FIG. 5.

Continuing with reference to FIG. 3, in some embodiments, process 300 can include generating 370 an output using the decision tree model. The output may provide information associated with a community assignment of the target individual. In some embodiments, the decision tree model may output a probability of a community assignment for a feature vector of a target haplotype dataset. The probability of a community assignment indicates a likelihood of the individual belonging to the community. This may include computing a score such as a probability for each model.

In some embodiments, the decision tree model may assign a level of confidence to the outcome, such as low, medium, and high. In some embodiments, the level of confidence may be associated with a likelihood that the target individual belongs to the community. In some embodiments, the level of confidence may be based on the classification probability. Based on the outcomes and the level of confidence, the output from the model may indicate whether the target individual is a member of the community.

The process 300 may be used for various communities to see how many communities to which the target individual is assigned. By running the data of the target individual through a number of community models, multiple community assignments may be obtained. In some embodiments, the prediction may include one or more community assignments. For example, an individual may be predicted to belong to an Irish community, a Jewish community and a Finnish community.

FIG. 4D is a block diagram illustrating a process for determining data classification estimation of a target named entity based on the inheritance dataset of the target named entity, in accordance with some embodiments. A target individual may be an example of a target named entity. A haplotype may be an example of an inheritance dataset and may also be referred to as a phased inheritance dataset. An ethnicity estimation may be an example of a data classification estimation. While in the discussion below the haplotype dataset is used as the main example of the inheritance data, various embodiments may also apply to other suitable inheritance data. The process may be performed by the ethnicity estimation engine 245. The ethnicity estimation engine 245 estimates the ethnicity composition of a genetic dataset of a target individual. The genetic datasets used by the ethnicity estimation engine 245 may be haplotype datasets. For example, the ethnicity estimation engine 245 estimates the ancestral origins (e.g., ethnicity, genetic community, etc.) based on the individual's genotypes or haplotypes at the SNP sites. To take a simple example of three ancestral populations corresponding to African, European and Native American communities, an admixed user may have nonzero estimated ethnicity proportions for all three ancestral populations, with an estimate such as [0.05, 0.65, 0.30], indicating that the user's genome is 5% attributable to African ethnicity, 65% attributable to European ethnicity and 30% attributable to Native American ethnicity. The ethnicity estimation engine 245 generates the ethnic composition estimate and stores the estimated ethnicities/genetic communities in a data store of computing server 130 with a pointer in association with a particular user.

In some embodiments, the ethnicity estimation engine 245 divides 450 a target inheritance dataset into a plurality of windows (e.g., about 1000 windows). Each window includes a small number of SNPs (e.g., 300 SNPs). The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 may determine 460 per-window data classification estimates using a string kernel method that is described in the process 300. The ethnicity estimation engine 245 determines the emission probabilities by comparing SNPs in the window corresponding to the target genetic dataset to corresponding SNPs in the windows in various reference panel samples of different genetic communities stored in the reference panel sample store 240. The transition probability between two nodes represents the likelihood of transition from one node to another across two levels.

The ethnicity estimation engine 245 may determine 470 an overall data classification composition using the inter-window HMM. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target genetic dataset by determining the label compositions of the nodes that are included in the determined path. In some embodiments, the ethnicity estimation engine 245 may use a directed acyclic graph model to determine the ethnic composition of the target genetic dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

FIG. 4E is a flowchart depicting an example process for predicting data classification using a string kernel model, in accordance with some embodiments. A target individual may be an example of a target named entity. A community classification may be an example of the data classification. A haplotype may be an example of an inheritance dataset and may also be referred to as a phased inheritance dataset. While in the discussion below the haplotype dataset is used as the main example of the inheritance data, various embodiments may also apply to other suitable inheritance data. The process may be performed by one or more engines of the computing server 130 illustrated in FIG. 2, such as ethnicity estimation engine 245. The process may be embodied as a software algorithm that may be stored as computer instructions that are executable by one or more processors. The instructions, when executed by the processors, cause the processors to perform various steps in the process. In various embodiments, the process may include additional, fewer, or different steps. While various steps in process may be discussed with the use of computing server 130, each step may be performed by a different computing device.

In some embodiments, the computer server 130 may pre-process the haplotype datasets for performing the full distance matrix calculation. For example, the process can include packing 402 a pre-determined number of matched data points into a data object, to reduce computing space usage thus reducing the runtime of the calculation. A SNP may be an example of the data point and may also be referred to as a site in an inheritance dataset. Conventionally, each SNP may be represented by a binary value (e.g., 0, or 1), which takes up at least one byte or more per SNP. If there are many SNPs, this becomes a space- and time-intensive process for performing the full distance matrix calculation. In one example, the pre-determined number may be 16. The computer server 130 packs every 16 SNPs into a “np.unit16” object (e.g., a 16-bit unsigned integer in, e.g., NumPy). The state of the 16 SNPs may be stored in 2 bytes (instead of using 16 separate bytes). This reduces space usage by 8 times because the multiple SNPs are packed into a single integer. It may also speed up the computation by a factor of 16, reducing the original complexity from O(mn) to O(mn/16) (here, m is the number of unique sites for a particular reference region/window in a reference panel, and n is the number of total reference windows/regions in the reference panel).

In some embodiments, the process can include selecting 404 a matched data string containing at least one perfect matched data object between the target inheritance dataset and the reference inheritance dataset. A SNP may be an example of the data point and may also be referred to as a site in an inheritance dataset. A haplotype may be an example of an inheritance dataset and may also be referred to as a phased inheritance dataset. The computer server 130 may only start counting a match when there is a perfect window match. A perfect window match may refer to an exact match across a 16-SNP window, e.g., a perfect match of all 16 SNPs packed into a data object. After detecting a perfect match in a segment of 16 SNPs, the computer server 130 may continue track contiguous matches in both directions, e.g., from left to right to move forward along the sequence; and from right to left to move backward along the sequence. In some implementations, the computer server 130 may identify a single SNP mismatch within an otherwise matching 16-SNP window. In this case, the computer server 130 may “flip” or “correct” the single SNP mismatch. For example, rather than stopping the match when one mismatch occurs, the computer server 130 may identify this single mismatch and adjust to still consider the sequence as mostly matching. In some embodiments, the computer server 130 may save potential edge cases of single mismatches that need information from other windows to decide whether the mismatched sited need to be flipped or not. Edge cases arise when the single mismatch happens at the boundary of the 16-SNP window. In this case, the computer server 130 may need information from the adjacent window(s) to decide if the mismatch may be “flipped” and still be considered part of a contiguous match. For example, if there is a mismatch at the last site of one 16-SNP window and the first position of the next window, the computer server 130 may evaluate both windows together to determine if they collectively form a contiguous match.

In some embodiments, the process can include performing 406 a full distance matrix calculation to determine a similarity metric between a target inheritance dataset and the reference inheritance datasets. A haplotype may be an example of an inheritance dataset and may also be referred to as a phased inheritance dataset. The string kernel model may include computation of a full distance matrix calculation. The computer server 130 may compute pairwise distances between the target haplotype dataset and each reference haplotype dataset. The result is a matrix where each element represents the distance between a pair of the target haplotype dataset and a reference haplotype dataset. In some implementations, the computer server 130 may identify and measure matched segments of exact or nearly exact contiguous matches between the target haplotype dataset and the reference haplotype datasets, and the contiguous matched segments are at least 33 base pairs (bp) long, e.g., including at least 33 matches SNPs. In some examples, the computer server 130 may perform a bitwise XOR operation between the target haplotype dataset and the reference haplotype datasets to determine differences at the SNP level.

In some embodiments, the process can include selecting 408 a modeling frequency to determine distances between the target inheritance dataset and the reference inheritance datasets. A haplotype may be an example of an inheritance dataset and may also be referred to as a phased inheritance dataset. In some embodiments, a haplotype dataset of a reference individual may appear multiple times in in a dataset or reference population. A repeated reference haplotype dataset shows up multiple times in the reference haplotype datasets. When performing the full distance matrix calculation, the repeated haplotype dataset may affect the calculation of the distances between a target haplotype and the references haplotypes, if the repeated haplotype dataset is counted once or more than once.

The modeling frequency reflects how to treat these repeated haplotype datasets. In one example, the modeling frequency is a “unique” modeling frequency, where each reference haplotype dataset is considered only once, regardless of how many times that reference haplotype dataset appears in the population. If a reference haplotype dataset appears multiple times (e.g., due to duplicates or multiple samples), it is counted only once. In another example, the modeling frequency is a “frequency” modeling frequency, where each reference haplotype dataset is counted based on how many times it appears in the population. The distances between the target haplotype dataset and all reference haplotype datasets from each reference population account for how often each reference haplotype dataset appears. In yet another example, the modeling frequency may include both “unique” and “frequency” modeling frequencies, which is a hybrid approach of the “unique” modeling frequency and the “frequency” modeling frequency. This approach includes distances of the target haplotype dataset with only unique reference haplotype datasets from each reference population, counting each reference haplotype dataset by the number of times it appears in each population.

Continuing with reference to FIG. 4E, in some embodiments, the process can include generating 410 a feature vector for the target inheritance dataset based on a result of the full distance matrix calculation. A haplotype may be an example of an inheritance dataset and may also be referred to as a phased inheritance dataset. Based on the result of the full distance matrix calculation, the computer server 130 may select a set of features for each reference region to form a feature vector. For example, the computer server 130 may select 3 features: max, min, and variance, as the set of features for each reference region. In one example, the set of features may include 13 features, including, mean, median, max, min, standard deviation, variance, skew, kurtosis, and 5 scaled histogram bins (max specific per population—using the highest value within each individual population to determine the upper limit for scaling or binning data). In another example, the set of features may include, non-scaled histogram bins (with optimized number of bins experimented), mean, max, and min. In yet another example, the set of features may include non-scaled histogram bins (max the same for all populations—using a standardized maximum value across different datasets, regardless of their actual individual maximums, with optimized number of bins experimented). In still another example, the set of features may include, mean, max, min, median, skew, kurtosis, standard deviation, variance and non-scaled histogram bins on quantile 0-25% and 65-100%.

Continuing with reference to FIG. 4E, in some embodiments, the process can include applying 412 a decision tree model to the feature vector by tuning hyperparameters of the decision tree model with a two-step process. In some embodiments, the computer server 130 may tune the hyperparameters to determine an optimal set of hyperparameters for the decision tree model. Hyperparameters are the settings that control the behavior of the decision tree model but are not learned from the data itself. Instead, they are set before training begins. In some embodiments, the computer server 130 may tune the hyperparameters with a two-step process.

At step one, the computer server 130 may tune tree structure and sample-related hyperparameters. For example, the “n_estimators” and “eta” (learning rate) are set to their default values, while the focus is on tuning the tree structure and sample-related parameters. These are the hyperparameters that control how the decision trees within the boosting framework are built. The tuned hyperparameters may include “max_depth” which describes the maximum depth a tree can grow to, “min_child_weight” which describes minimum number of instances required in a child node (with default=1), “colsample_bytree” which describes the number of features supplied to a tree (with default=1), “subsample” which describes the number of samples supplied to a tree (with default=1), and “gamma” which describes regularization (with default=0).

At step two, the computer server 130 may tune regularization and boosting hyperparameters. For example, the tuning process may focus on the boosting process itself by adjusting parameters related to regularization and the number of iterations. The tuned hyperparameters may include “n_estimators” which describes the maximum number of iterations (with default=100) and “eta” which describes the learning rate (with default=0.3). By splitting the tuning into these two steps, the computer server 130 isolates the complexity of tuning tree structure first and then optimize the boosting process for more refined control over model performance.

Continuing with reference to FIG. 4E, in some embodiments, the process can include receiving 414 the output from the decision tree model. The output may provide information associated with a community assignment of the target individual, e.g., a probability of a community assignment for the target individual. The accuracy of the output increases as the size of the reference panel (the dataset of reference individuals) grows. Larger reference panels provide more data points for comparison, which enhances the model's ability to make accurate predictions. In some embodiments, the computer server 130 may implement a sample size control, e.g., ensuring diversity, removing duplicates, or balancing population sizes, etc., which may lead to a more than 20% increase in accuracy for small reference panels. In some implementations, 69% of the computation time for an XGBoost model is spent calculating the full distance matrix. Based on the method described in FIG. 4E, the computer server 130 may reduce computational time of the full distance matrix by 20 times, which greatly improves the model's overall speed. In some implementations, 25% of the computational time is used for feature computation. Based on the method described in FIG. 4E, the computer server 130 may reduce this computational time by 10 times, further contributing to overall efficiency gains. By reducing time spent on distance matrix calculations and feature computation, the computer server 130 significantly improves the computational speed.

### Example Machine Learning Models

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various community assignment performed by the community assignment engine 230, and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to assign community for an individual, the training samples may be associated with haplotype datasets. The training samples may be generated based on the genetic data. The labels for each training sample may be binary or multi-class. In training a machine learning model for assigning a community for an individual, the training labels may include a positive label that indicates that the individual belongs to a community and a negative label that indicates that the individual does not belong to a community. In some embodiments, the training labels may also be multi-class.

By way of example, the training set may include multiple past records of haplotypes with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. For example, in a machine learning model that is used to assign a community for an individual, the features in a feature vector may include reference haplotypes (e.g., an enriched haplotype), and the value of each element indicates the present or absence of the reference haplotype in the individual associated with the training sample, and/or any features that are selected as discussed in FIGS. 4A, 4B, and 4C. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In various embodiments, the error rate may be measured as cross-entropy loss, L1 loss (e.g., the sum of absolute differences between the predicted values and the actual value), L2 loss (e.g., the sum of squared distances).

Referring to FIG. 5, a structure of an example model is illustrated, in accordance with some embodiments. In some embodiments, the model 500 may be an ensemble decision tree model, such as an XGBoost model. In some embodiments, the model 500 builds an ensemble of decision trees in sequence to improve predictive accuracy by incrementally reducing the residuals of prior trees. This process starts with the input data, where each instance has feature values that will be used by the model 500 to split nodes in each decision tree. The model 500 begins with an initial prediction. For example, the model 500 may set the initial prediction to a constant value, such as the mean of the target values in regression or a fixed probability for classification. This initial prediction may act as a baseline estimate from which the model will refine its predictions through a series of adjustments by successive trees.

The first tree is then trained on the residuals, which represent the error between the initial prediction and the actual target values. Each residual indicates how much the initial prediction deviates from the true value for each instance. In some embodiments, XGBoost computes these residuals as gradients, which guide the model 500 in determining the direction and magnitude of adjustments required to correct the initial prediction. The model 500 then splits nodes within this first tree by choosing features and split points that maximize the information gain. This involves evaluating possible splits across all features and selecting the one that minimizes the residual error most effectively. As a result, each leaf node in the tree corresponds to a region of the feature space, and each region is assigned a specific leaf weight that reflects the correction needed for the instances that fall within that node. This weight serves as an incremental adjustment to the prediction, bringing it closer to the true value.

Once the first tree is added to the ensemble, XGBoost updates the predictions by combining the initial prediction with the correction provided by the first tree. The ensemble prediction after the first tree is calculated. This learning rate controls the contribution of each tree to the ensemble prediction, preventing large corrections that could lead to overfitting. After updating the predictions, the model 500 recalculates the residuals based on these new predictions. These residuals now serve as the target for the next tree, ensuring that each successive tree learns from and corrects the errors made by the previous trees.

In some embodiments, XGBoost continues to add trees sequentially, with each tree being trained on the residuals from the previous prediction. Each new tree attempts to bring the updated predictions closer to the actual target values by producing adjustments that reduce the remaining error. After each tree is added, the overall prediction for each instance is updated. This iterative refinement process allows XGBoost to converge gradually toward the true values, with each tree improving upon the ensemble's accuracy.

While XGBoost doesn't directly average predictions in the way that bagging methods like random forests do, its final prediction may be thought of as a smoothed or cumulative prediction over all trees in the ensemble. The accumulated prediction for each instance in the model 500 is the weighted sum of all the trees, where each tree's contribution is scaled by the learning rate. For regression tasks, this ensemble prediction is used as the final output. In classification tasks, XGBoost often applies a logistic or softmax transformation to the accumulated prediction score, turning it into a probability estimate.

A machine learning model may include certain layers, nodes, kernels and/or coefficients. Training of a neural network may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes. For example, a computing device may receive a training set that includes haplotypes of training samples. Each training sample in the training set may be assigned with labels indicating whether an associated individual belongs to a community. The computing device, in a forward propagation, may use the machine learning model to generate predicted community that the individual belongs to. The computing device may compare the predicted community assignment with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing community assignment or another suitable task for which the model is trained.

### Computing Machine Architecture

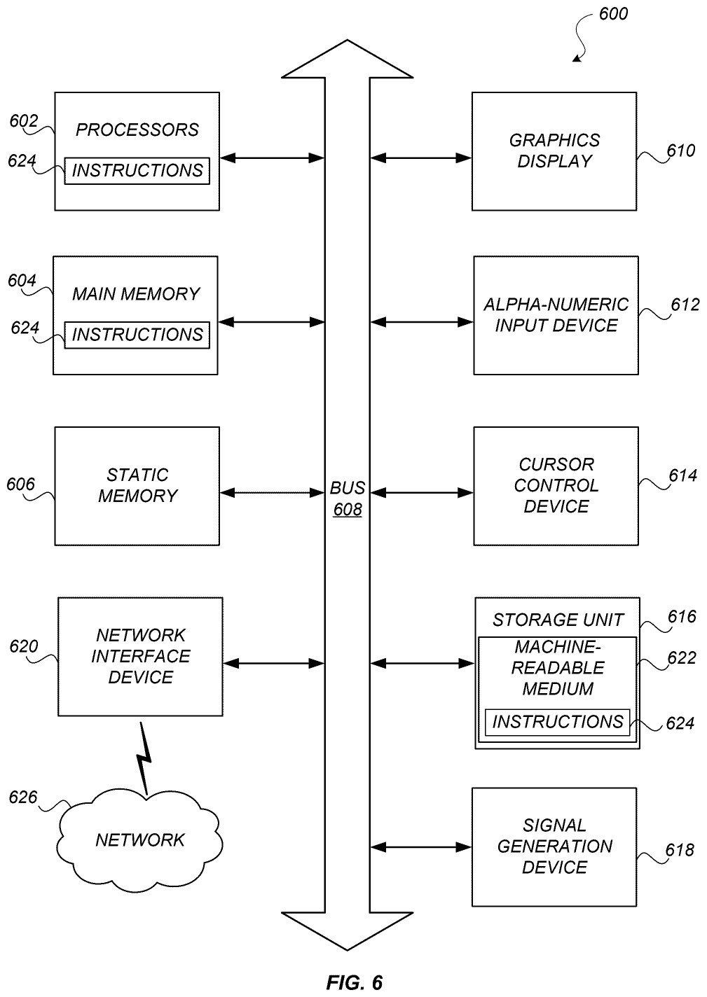

FIG. 6 is a block diagram illustrating components of an example computing machine that is capable of reading instructions from a computer-readable medium and execute them in a processor (or controller). A computer described herein may include a single computing machine shown in FIG. 6, a virtual machine, a distributed computing system that includes multiple nodes of computing machines shown in FIG. 6, or any other suitable arrangement of computing devices.

By way of example, FIG. 6 shows a diagrammatic representation of a computing machine in the example form of a computer system 600 within which instructions 624 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 6 may correspond to any software, hardware, or combined components shown in FIGS. 1 and 2, including but not limited to, the client device 110, the computing server 130, and various engines, interfaces, terminals, and machines shown in FIG. 2. While FIG. 6 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 624 that specify actions to be taken by that machine. Further, while only a single machine is illustrated, the term “machine” and “computer” may also be taken to include any collection of machines that individually or jointly execute instructions 624 to perform any one or more of the methodologies discussed herein.

The example computer system 600 includes one or more processors 602 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 600 may also include a memory 604 that store computer code including instructions 624 that may cause the processors 602 to perform certain actions when the instructions are executed, directly or indirectly by the processors 602. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 602 and reduces the space required for the memory 604. For example, the database processing techniques and machine learning methods described herein reduce the complexity of the computation of the processors 602 by applying one or more novel techniques that simplify the steps in training, reaching convergence, and generating results of the processors 602. The algorithms described herein also reduces the size of the models and datasets to reduce the storage space requirement for memory 604.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though in the specification or the claims may refer some processes to be performed by a processor, this should be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situations such as in multiple processors of a system in a chip, in Cloud computing, or in distributed computing.

The computer system 600 may include a main memory 604, and a static memory 606, which are configured to communicate with each other via a bus 608. The computer system 600 may further include a graphics display unit 610 (e.g., a plasma display panel (PDP), a liquid crystal display (LCD), a projector, or a cathode ray tube (CRT)). The graphics display unit 610, controlled by the processors 602, displays a graphical user interface (GUI) to display one or more results and data generated by the processes described herein. The computer system 600 may also include alphanumeric input device 612 (e.g., a keyboard), a cursor control device 614 (e.g., a mouse, a trackball, a joystick, a motion sensor, or other pointing instruments), a storage unit 616 (a hard drive, a solid-state drive, a hybrid drive, a memory disk, etc.), a signal generation device 618 (e.g., a speaker), and a network interface device 620, which also are configured to communicate via the bus 608.

The storage unit 616 includes a computer-readable medium 622 on which is stored instructions 624 embodying any one or more of the methodologies or functions described herein. The instructions 624 may also reside, completely or at least partially, within the main memory 604 or within the processor 602 (e.g., within a processor's cache memory) during execution thereof by the computer system 600, the main memory 604 and the processor 602 also constituting computer-readable media. The instructions 624 may be transmitted or received over a network 626 via the network interface device 620.

While computer-readable medium 622 is shown in an example embodiment to be a single medium, the term “computer-readable medium” should be taken to include a single medium or multiple media (e.g., a centralized or distributed database, or associated caches and servers) able to store instructions (e.g., instructions 624). The computer-readable medium may include any medium that is capable of storing instructions (e.g., instructions 624) for execution by the processors (e.g., processors 602) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Embodiments

Clause 1. A computer-implemented method, comprising: receiving a target haplotype dataset of a target individual; receiving a plurality of reference haplotype datasets corresponding to a plurality of reference individuals, each reference haplotype dataset belonging to a reference individual; generating a feature vector corresponding to the target haplotype dataset, wherein generating the feature vector comprises: applying a string kernel model to matched segments between the target haplotype dataset and each of the reference haplotype datasets, wherein the string kernel model determines a similarity metric based on a polynomial value for contiguous matched sites of the matched segments between the target haplotype dataset and each of the reference haplotype datasets; generating the feature vector based on results of applying the string kernel model to the matched segments between the target haplotype dataset and the plurality of reference haplotype datasets; applying a decision tree model to the feature vector corresponding to the target haplotype dataset; and generating an output using the decision tree model, the output providing information associated with a community assignment of the target individual.

Clause 2. The method of clause 1, wherein generating a feature vector further comprises: dividing the target haplotype dataset and the plurality of reference haplotype datasets into a plurality of reference regions, each reference region comprising a sequence of single nucleotide polymorphisms (SNPs); and identifying the matched segments between the target haplotype dataset and each of the reference haplotype datasets in each reference region.

Clause 3. The method of clause 1, wherein identifying the matched segments comprises: for each reference region, comparing each of SNPs sites in the target haplotype dataset with corresponding SNPs sites in each of the reference haplotype datasets.

Clause 4. The method of clause 1, wherein applying a string kernel model to matched segments comprises: determining, based on the matched segments, a plurality of similarity scores between the target haplotype dataset and the plurality of reference haplotype datasets, each similarity score indicating a level of similarity between the target haplotype dataset and one of the plurality of reference haplotype dataset; obtaining a similarity score distribution based on the determined plurality of similarity scores for the target haplotype dataset; and selecting one or more statistical parameters associated with the similarity score distribution as features of the feature vector.

Clause 5. The method of clause 1, wherein the string kernel model includes one or more parameters associated with weight assigned to the contiguous matched sites of the matched segments.

Clause 6. The method of clause 5, wherein the string kernel model assigns a higher weight to a matched segment with more contiguous matched sites than a matched segment with less contiguous sites.

Clause 7. The method of clause 1, wherein the decision tree model includes XGBoost.

Clause 8. A computer-readable storage medium having stored thereon computer-executable instructions that, when executed by one or more processors, cause the one or more processors to perform operations, comprising: receiving a target haplotype dataset of a target individual; receiving a plurality of reference haplotype datasets corresponding to a plurality of reference individuals, each reference haplotype dataset belonging to a reference individual; generating a feature vector corresponding to the target haplotype dataset, wherein generating the feature vector comprises: applying a string kernel model to matched segments between the target haplotype dataset and each of the reference haplotype datasets, wherein the string kernel model determines a similarity metric based on a polynomial value for contiguous matched sites of the matched segments between the target haplotype dataset and each of the reference haplotype datasets; generating the feature vector based on results of applying the string kernel model to the matched segments between the target haplotype dataset and the plurality of reference haplotype datasets; applying a decision tree model to the feature vector corresponding to the target haplotype dataset; and generating an output using the decision tree model, the output providing information associated with a community assignment of the target individual.

Clause 9. The computer-readable storage medium of clause 8, wherein generating a feature vector further comprises: dividing the target haplotype dataset and the plurality of reference haplotype datasets into a plurality of reference regions, each reference region comprising a sequence of single nucleotide polymorphisms (SNPs); and identifying the matched segments between the target haplotype dataset and each of the reference haplotype datasets in each reference region.

Clause 10. The computer-readable storage medium of clause 8, wherein identifying the matched segments comprises: for each reference region, comparing each of SNPs sites in the target haplotype dataset with corresponding SNPs sites in each of the reference haplotype datasets.

Clause 11. The computer-readable storage medium of clause 8, wherein applying a string kernel model to matched segments comprises: determining, based on the matched segments, a plurality of similarity scores between the target haplotype dataset and the plurality of reference haplotype datasets, each similarity score indicating a level of similarity between the target haplotype dataset and one of the plurality of reference haplotype dataset; obtaining a similarity score distribution based on the determined plurality of similarity scores for the target haplotype dataset; and selecting one or more statistical parameters associated with the similarity score distribution as features of the feature vector.

Clause 12. The computer-readable storage medium of clause 8, wherein the string kernel model includes one or more parameters associated with weight assigned to the contiguous matched sites of the matched segments.

Clause 13. The computer-readable storage medium of clause 12, wherein the string kernel model assigns a higher weight to a matched segment with more contiguous matched sites than a matched segment with less contiguous sites.

Clause 14. The computer-readable storage medium of clause 8, wherein the decision tree model includes XGBoost.

Clause 15. A computer system, comprising: one or more processors; and a hardware storage device having stored thereon computer-executable instructions that, when executed by the one or more processors, causes the computer system to perform operations, comprising: receiving a target haplotype dataset of a target individual; receiving a plurality of reference haplotype datasets corresponding to a plurality of reference individuals, each reference haplotype dataset belonging to a reference individual; generating a feature vector corresponding to the target haplotype dataset, wherein generating the feature vector comprises: applying a string kernel model to matched segments between the target haplotype dataset and each of the reference haplotype datasets, wherein the string kernel model determines a similarity metric based on a polynomial value for contiguous matched sites of the matched segments between the target haplotype dataset and each of the reference haplotype datasets; generating the feature vector based on results of applying the string kernel model to the matched segments between the target haplotype dataset and the plurality of reference haplotype datasets; applying a decision tree model to the feature vector corresponding to the target haplotype dataset; and generating an output using the decision tree model, the output providing information associated with a community assignment of the target individual.

Clause 16. The computer system of clause 15, wherein generating a feature vector further comprises: dividing the target haplotype dataset and the plurality of reference haplotype datasets into a plurality of reference regions, each reference region comprising a sequence of single nucleotide polymorphisms (SNPs); and identifying the matched segments between the target haplotype dataset and each of the reference haplotype datasets in each reference region.

Clause 17. The computer system of clause 15, wherein identifying the matched segments comprises: for each reference region, comparing each of SNPs sites in the target haplotype dataset with corresponding SNPs sites in each of the reference haplotype datasets.

Clause 18. The computer system of clause 15, wherein applying a string kernel model to matched segments comprises: determining, based on the matched segments, a plurality of similarity scores between the target haplotype dataset and the plurality of reference haplotype datasets, each similarity score indicating a level of similarity between the target haplotype dataset and one of the plurality of reference haplotype dataset; obtaining a similarity score distribution based on the determined plurality of similarity scores for the target haplotype dataset; and selecting one or more statistical parameters associated with the similarity score distribution as features of the feature vector.

Clause 19. The computer system of clause 15, wherein the string kernel model includes one or more parameters associated with weight assigned to the contiguous matched sites of the matched segments.

Clause 20. The computer system of clause 19, wherein the string kernel model assigns a higher weight to a matched segment with more contiguous matched sites than a matched segment with less contiguous sites.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, (6) U.S. Pat. No. 11,429,615, entitled “Linking Individual Datasets to a Database,” granted on Aug. 30, 2022, (7) U.S. Pat. No. 10,692,587, entitled “Global Ancestry Determination System,” granted on Jun. 23, 2020, and (8) U.S. Patent Application Publication No. US 2021/0034647, entitled “Clustering of Matched Segments to Determine Linkage of Dataset in a Database,” published on Feb. 4, 2021.

What is claimed is:

1. A computer-implemented method, comprising:
receiving a target inheritance dataset of a target named entity;
receiving a plurality of reference inheritance datasets corresponding to a plurality of reference named entities, each reference inheritance dataset belonging to a reference named entity;
generating a feature vector corresponding to the target inheritance dataset, wherein generating the feature vector comprises:
applying a string kernel model to matched data strings between the target inheritance dataset and each of the reference inheritance datasets, wherein the string kernel model determines a similarity metric based on a polynomial value for contiguous matched sites of the matched data strings between the target inheritance dataset and each of the reference inheritance datasets;
generating the feature vector based on results of applying the string kernel model to the matched data strings between the target inheritance dataset and the plurality of reference inheritance datasets;
applying a decision tree model to the feature vector corresponding to the target inheritance dataset; and
generating an output using the decision tree model, the output providing information associated with a data classification of the target named entity.

2. The method of claim 1, wherein generating a feature vector further comprises:
dividing the target inheritance dataset and the plurality of reference inheritance datasets into a plurality of reference regions, each reference region comprising a sequence of single nucleotide polymorphisms (SNPs); and
identifying the matched data strings between the target inheritance dataset and each of the reference inheritance datasets in each reference region.

3. The method of claim 1, wherein identifying the matched data strings comprises:
for each reference region, comparing each of SNPs sites in the target inheritance dataset with corresponding SNPs sites in each of the reference inheritance datasets.

4. The method of claim 1, wherein applying a string kernel model to matched data strings comprises:
determining, based on the matched data strings, a plurality of similarity scores between the target inheritance dataset and the plurality of reference inheritance datasets, each similarity score indicating a level of similarity between the target inheritance dataset and one of the plurality of reference inheritance dataset;
obtaining a similarity score distribution based on the determined plurality of similarity scores for the target inheritance dataset; and
selecting one or more statistical parameters associated with the similarity score distribution as features of the feature vector.

5. The method of claim 1, wherein the string kernel model includes one or more parameters associated with weight assigned to the contiguous matched sites of the matched data strings.

6. The method of claim 5, wherein the string kernel model assigns a higher weight to a matched data string with more contiguous matched sites than a matched data string with less contiguous sites.

7. The method of claim 1, wherein the decision tree model includes XGBoost.

8. A computer-readable storage medium having stored thereon computer-executable instructions that, when executed by one or more processors, cause the one or more processors to perform operations, comprising:
receiving a target haplotype dataset of a target individual;
receiving a plurality of reference haplotype datasets corresponding to a plurality of reference named entities, each reference haplotype dataset belonging to a reference named entity;
generating a feature vector corresponding to the target haplotype dataset, wherein generating the feature vector comprises:
applying a string kernel model to matched data strings between the target haplotype dataset and each of the reference haplotype datasets, wherein the string kernel model determines a similarity metric based on a polynomial value for contiguous matched sites of the matched data strings between the target haplotype dataset and each of the reference haplotype datasets;
generating the feature vector based on results of applying the string kernel model to the matched data strings between the target haplotype dataset and the plurality of reference haplotype datasets;
applying a decision tree model to the feature vector corresponding to the target haplotype dataset; and
generating an output using the decision tree model, the output providing information associated with a data classification of the target named entity.

9. The computer-readable storage medium of claim 8, wherein generating a feature vector further comprises:
dividing the target haplotype dataset and the plurality of reference haplotype datasets into a plurality of reference regions, each reference region comprising a sequence of single nucleotide polymorphisms (SNPs); and
identifying the matched data strings between the target haplotype dataset and each of the reference haplotype datasets in each reference region.

10. The computer-readable storage medium of claim 8, wherein identifying the matched data strings comprises:
for each reference region, comparing each of SNPs sites in the target haplotype dataset with corresponding SNPs sites in each of the reference haplotype datasets.

11. The computer-readable storage medium of claim 8, wherein applying a string kernel model to matched data strings comprises:
determining, based on the matched data strings, a plurality of similarity scores between the target haplotype dataset and the plurality of reference haplotype datasets, each similarity score indicating a level of similarity between the target haplotype dataset and one of the plurality of reference haplotype dataset;
obtaining a similarity score distribution based on the determined plurality of similarity scores for the target haplotype dataset; and
selecting one or more statistical parameters associated with the similarity score distribution as features of the feature vector.

12. The computer-readable storage medium of claim 8, wherein the string kernel model includes one or more parameters associated with weight assigned to the contiguous matched sites of the matched data strings.

13. The computer-readable storage medium of claim 12, wherein the string kernel model assigns a higher weight to a matched data string with more contiguous matched sites than a matched data string with less contiguous sites.

14. The computer-readable storage medium of claim 8, wherein the decision tree model includes XGBoost.

15. A computer system, comprising:
one or more processors; and
a hardware storage device having stored thereon computer-executable instructions that, when executed by the one or more processors, causes the computer system to perform operations, comprising:
receiving a target inheritance dataset of a target named entity;
receiving a plurality of reference inheritance datasets corresponding to a plurality of reference named entities, each reference inheritance dataset belonging to a reference named entity;
generating a feature vector corresponding to the target inheritance dataset, wherein generating the feature vector comprises:
applying a string kernel model to matched data strings between the target inheritance dataset and each of the reference inheritance datasets, wherein the string kernel model determines a similarity metric based on a polynomial value for contiguous matched sites of the matched data strings between the target inheritance dataset and each of the reference inheritance datasets;
generating the feature vector based on results of applying the string kernel model to the matched data strings between the target inheritance dataset and the plurality of reference inheritance datasets;
applying a decision tree model to the feature vector corresponding to the target inheritance dataset; and
generating an output using the decision tree model, the output providing information associated with a data classification of the target named entity.

16. The computer system of claim 15, wherein generating a feature vector further comprises:
dividing the target inheritance dataset and the plurality of reference inheritance datasets into a plurality of reference regions, each reference region comprising a sequence of single nucleotide polymorphisms (SNPs); and
identifying the matched data strings between the target inheritance dataset and each of the reference inheritance datasets in each reference region.

17. The computer system of claim 15, wherein identifying the matched data strings comprises:
for each reference region, comparing each of SNPs sites in the target inheritance dataset with corresponding SNPs sites in each of the reference inheritance datasets.

18. The computer system of claim 15, wherein applying a string kernel model to matched data strings comprises:
determining, based on the matched data strings, a plurality of similarity scores between the target inheritance dataset and the plurality of reference inheritance datasets, each similarity score indicating a level of similarity between the target inheritance dataset and one of the plurality of reference inheritance dataset;
obtaining a similarity score distribution based on the determined plurality of similarity scores for the target inheritance dataset; and
selecting one or more statistical parameters associated with the similarity score distribution as features of the feature vector.

19. The computer system of claim 15, wherein the string kernel model includes one or more parameters associated with weight assigned to the contiguous matched sites of the matched data strings.

20. The computer system of claim 19, wherein the string kernel model assigns a higher weight to a matched data string with more contiguous matched sites than a matched data string with less contiguous sites.
